(19) United States
(12) Patent Application Publication
(10) Pub. No.: US 2016/0343998 A1
(43) Pub. Date: Nov. 24, 2016

(54) Batteries and a Method for Forming a Battery Cell Arrangement

(71) Applicant: Infineon Technologies AG, Neubiberg (DE)

(72) Inventor: Friedrich Kroener, Villach (AT)

(21) Appl. No.: 15/160,352

(22) Filed: May 20, 2016

(30) Foreign Application Priority Data
May 21, 2015 (DE) 102015108070.2

(51) Int. Cl. H01M 2/02; H01M 2/10; H01M 10/058; H01M 10/0525

(52) U.S. Cl. CPC H01M 2/0267; H01M 10/0525; H01M 2/1016; H01M 2/0285; H01M 10/058

(57) ABSTRACT

A battery includes a plurality of battery cells encapsulated by an encapsulation structure. The battery also includes an embedding structure separating neighboring ones of the battery cells. An embedding material of at least a part of the embedding structure is arranged between the neighboring battery cells. A shear strength of the embedding material is less than 30% of a shear strength of an encapsulation material of at least a part of the encapsulation structure.

### PRIORITY CLAIM

This application claims priority to German Patent Application No. 10 2015 108 070.2 filed on 21 May 2015, the content of said application incorporated herein by reference in its entirety.

### TECHNICAL FIELD

Embodiments relate to battery arrangements and in particular to batteries and a method for forming a battery cell arrangement.

### BACKGROUND

Batteries may be potentially hazardous due to the formation of flammable substances during impact or mechanical destruction. Limits are thus placed on the size and energy density of batteries to minimize hazards due to accidents. It is desired to produce batteries with high energy density and which are less hazardous.

### SUMMARY

It is a demand to provide batteries which are safer and which have high energy density.

Such a demand may be satisfied by the subject matter of the claims.

Some embodiments relate to a battery comprising a plurality of battery cells. The battery cells of the plurality of battery cells are respectively encapsulated by an encapsulation structure. The battery comprises an embedding structure separating neighboring battery cells of the plurality of battery cells. An embedding material of at least a part of the embedding structure is arranged between the neighboring battery cells. A shear strength of the embedding material of at least a part of the embedding structure is less than 30% of a shear strength of an encapsulation material of at least a part of the encapsulation structure

Some embodiments relate to a battery comprising a plurality of battery cells. The battery cells of the plurality of battery cells are respectively encapsulated by an encapsulation structure. The battery comprises an embedding structure separating neighboring battery cells of the plurality of battery cells. An embedding material of at least a part of the embedding structure is arranged between the neighboring battery cells. A shear strength of an encapsulation material of at least a part of the encapsulation structure is larger than a tensile strength of the embedding material of at least a part of the embedding structure.

Some embodiments relate to a method for forming a battery cell arrangement. The method comprises forming at least one trench in a first supporting substrate and depositing a first metal encapsulation element of an encapsulation structure in the at least one trench of the first supporting substrate. The method further includes forming at least one trench in a second supporting substrate and depositing a second metal encapsulation element of the encapsulation structure in the at least one trench of the second supporting substrate. The method further includes joining the first supporting substrate and the second supporting substrate so that the encapsulation structure is formed around a battery cell.

Those skilled in the art will recognize additional features and advantages upon reading the following detailed description and on viewing the accompanying drawings.

### BRIEF DESCRIPTION OF THE FIGURES

Some embodiments of apparatuses and/or methods will be described in the following by way of example only, and with reference to the accompanying figures, in which:

FIG. 1A shows a schematic illustration of a cross-section of a battery according to an embodiment;

FIG. 1B shows a schematic illustration of a top view of a battery according to an embodiment;

FIG. 2 shows a schematic illustration of a further battery according to an embodiment;

FIG. 3 shows a flow chart of a method for forming a battery cell arrangement according to an embodiment;

FIG. 4 shows a schematic illustration of a battery according to an embodiment;

FIG. 5 shows a flow chart of a method for forming a battery according to an embodiment; and

FIG. 6 shows a flow chart of a method for forming a further battery according to an embodiment.

### DETAILED DESCRIPTION

Various example embodiments will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

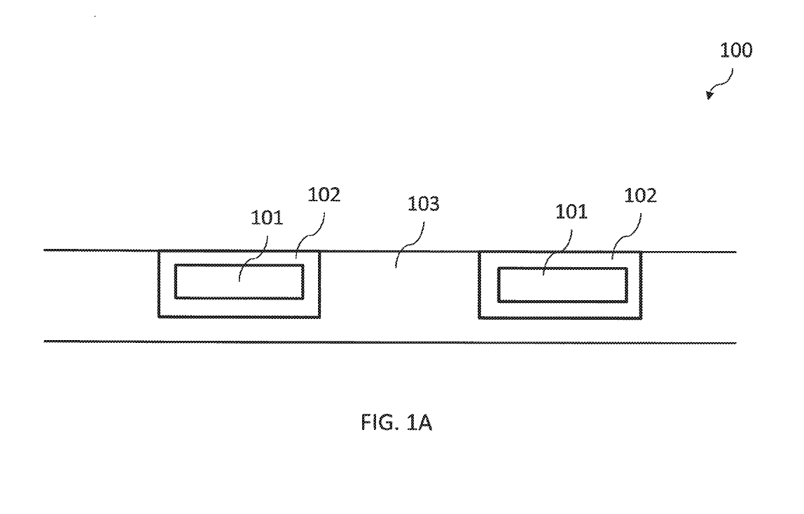

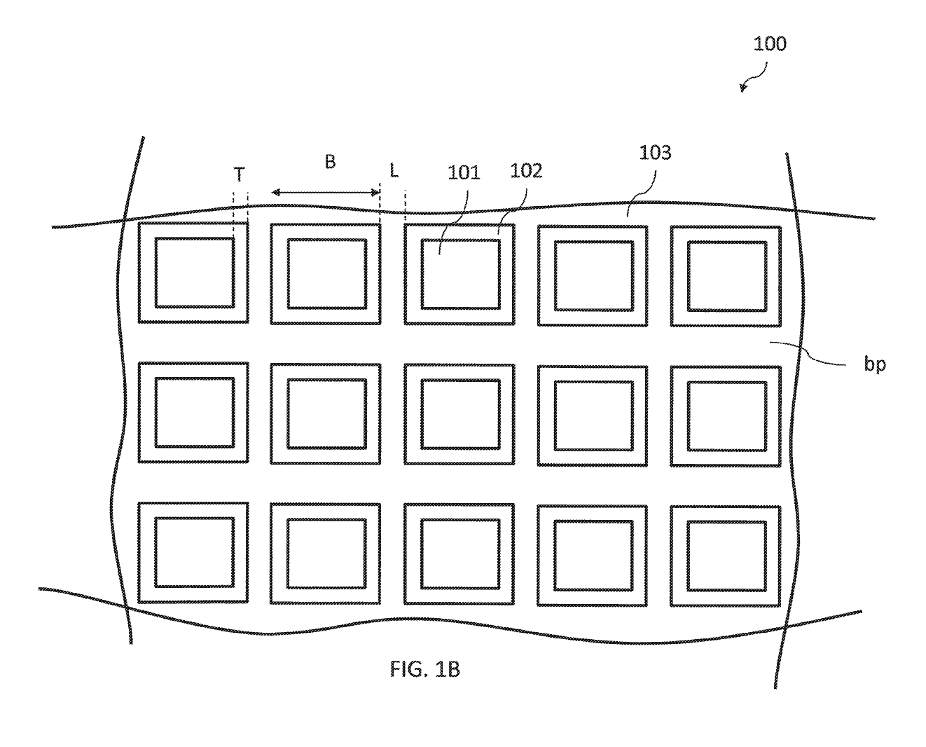

FIG. 1A shows a schematic illustration of a battery 100 according to an embodiment. The battery 100 includes a plurality of battery cells 101. The battery cells of the plurality of battery cells 101 are respectively encapsulated by an encapsulation structure 102. The battery 100 further includes an embedding structure 103 separating neighboring battery cells of the plurality of battery cells 101. An embedding material of at least a part of the embedding structure 103 is arranged between the neighboring battery cells 101. A shear strength of the embedding material of at least a part of the embedding structure 103 is less than 30% of a shear strength of an encapsulation material of at least a part of the encapsulation structure 102.

Due to the shear strength of the embedding material (e.g. the first shear strength) being less than the shear strength of the encapsulation material (e.g. the second shear strength), the safety of the batteries (e.g. lithium ion batteries) may be improved, and potential hazards may be reduced, for example. For example, in case of an external impact, breakage may occur along breakage points of the embedding structure 103, while the encapsulation structure 102 may be unbroken, thus leaving the individual battery cells 101 intact, for example.

The battery 100 may be a rechargeable battery or a secondary battery, for example.

The battery cells 101 of the plurality of battery cells 101 may be lithium ion battery cells, for example. For example, a battery cell 101 (e.g. each battery cell) may include a cathode structure (e.g. the positive electrode) and an anode structure (e.g. the negative electrode). Lithium ions may be transported between the cathode structure and the anode structure through an electrolyte. For example, the battery cell 101 may include an electrolyte for transporting lithium ions between the anode structure and the cathode structure. For example, lithium ions may be transported from the cathode structure to the anode structure and stored at the anode structure (during charging). Furthermore, lithium ions may be transported from the anode structure to the cathode structure during discharge. The battery cell 101 may further include a membrane structure (e.g. a separator structure) located between the anode structure and the cathode structure, for example.

The anode structure may include a metallic lithium layer, for example. The cathode structure may include a cathode material. The cathode material may include or may be Ni—Co—Al—Li-Oxide (nickel cobalt aluminum lithium oxide), for example.

As shown in the top view schematic illustration of the battery 100 in FIG. 1B, the battery cells 101 of the battery 100 may be arranged in a two-dimensional array, for example. The plurality of battery cells 101 may include two or more battery cells (e.g. more than 10, more than 20 or more than 50 battery cells), for example. The plurality of battery cells 101 may be electrically connected in parallel (or in series), for example. For example, in parallel, the respective anode structures of the plurality of battery cells 101 may be electrically connected to each other and the respective cathode structures of the plurality of battery cells 101 may be electrically connected to each other.

The battery 100 may include lithium ion battery cells (with a parallel arrangement) and a substantially metallic encapsulation (e.g. the encapsulation structure 102). The battery cells 101 may be embedded in a brittle body (e.g. the embedding structure 103), which in case of an external impact, breaks along the connection lines along the metallic encapsulated battery cells (in the embedding structure), for example.

A battery cell 101 may have a maximum lateral dimension, B, of between 5 mm and 20 mm (e.g. between 5 mm and 10 mm), for example. For example, the maximum lateral dimension may be a largest length of a lateral side of the battery cell 101. Optionally or alternatively, the maximum lateral dimension may be a largest length of a side of the battery cell 101 in a direction along (or parallel to) a main surface of a substrate (e.g. an embedding structure) in which the battery cell 101 is located, for example. Optionally or alternatively, the maximum lateral dimension may be a largest distance (e.g. a diagonal) between a first side of the battery cell and a second opposite side of the battery cell 101, for example.

The encapsulation structure 102 may at least partially surround (or partially or fully encapsulate) the respective battery cells of the plurality of battery cells 101. For example, each battery cell 101 may be at least partially (or fully) surrounded by an individual (e.g. a respective) encapsulation structure 102. The encapsulation structure 102 may form a protective structure or shell surrounding the battery cell 101. For example, the encapsulation structure 102 may be formed adjacent to at least one side (or to more than one side) of the battery cell 101. For example, the encapsulation structure 102 of a battery cell 101 may be formed (directly) adjacent to one or more different parts of the battery cell 101. For example, the encapsulation structure 102 may be formed (directly) adjacent to the anode structure of the battery cell 101, the cathode structure of the battery cell 101 and/or a membrane structure of the battery cell 101.

The encapsulation structure 102 may include a first encapsulation element. The first encapsulation element may be part of the encapsulation structure 102, for example. The first encapsulation element of the encapsulation structure 102 may be formed at least partially around (e.g. partially or fully encapsulating) the anode structure of the battery cell 101, for example. For example, the first encapsulation element of the encapsulation structure 102 may be formed adjacent (or directly adjacent) to at least part of the anode structure (e.g. adjacent or directly adjacent to at least one side of the anode structure, or e.g. adjacent or directly adjacent to more than one side of the anode structure). For example, the first encapsulation element of the encapsulation structure 102 may be formed between the anode structure and the embedding structure 103.

Additionally or optionally, the encapsulation structure 102 may include a second encapsulation element formed around (e.g. partially or fully encapsulating) the cathode structure of the battery cell 101, for example. The second encapsulation element may be part of the encapsulation structure 102, for example. The second encapsulation element of the encapsulation structure 102 may be formed at least partially around the cathode structure of the battery cell 101, for example. For example, second encapsulation element of the encapsulation structure 102 may be formed adjacent (or directly adjacent) to at least part of the cathode structure (e.g. adjacent or directly adjacent to at least one side of the cathode structure, or e.g. adjacent or directly adjacent to more than one side of the cathode structure). For example, the second encapsulation element of the encapsulation structure 102 may be formed between the cathode structure and the embedding structure 103.

The encapsulation structure 102 may have a minimum thickness, T, of between 10 μm and 100 μm (or e.g. between 15 μm and 80 μm or e.g. between 20 μm and 30 μm). For example, the encapsulation structure 103 may have a minimum thickness of about 25 μm. The minimum thickness may be the smallest thickness of the encapsulation structure 102 measured between the battery cell 101 and the embedding structure 103, for example.

The embedding structure 103 may separate neighboring battery cells of the plurality of battery cells. The embedding structure 103 may surround or may be formed around the encapsulation structure 102, for example. For example, the embedding structure 103 may embed at least part of the respective encapsulation structures 102 which may be adjacent (or directly adjacent) to the respective battery cells 101. For example, the embedding structure 103 may be formed between the respective encapsulation structures 102 which encapsulate respective neighboring battery cells 101. For example, the embedding structure 103 may be formed adjacent (or directly adjacent) to the respective encapsulation structures 102 which encapsulate respective neighboring battery cells 101.

A first portion of the embedding structure 103 may embed the first encapsulation element of the encapsulation structure 102, for example. For example, the first portion of the embedding structure 103 may be a first supporting substrate (e.g. a wafer or part of a wafer) and the first encapsulation element of the encapsulation structure 102 may be formed in or within the first supporting substrate.

A second portion of the embedding structure 103 may embed the second encapsulation element of the encapsulation structure 102, for example. For example, the second portion of the embedding structure 103 may be a second supporting substrate (e.g. a wafer or part of a wafer) and the second encapsulation element of the encapsulation structure 102 may be formed in or within the second supporting substrate.

A minimum lateral distance between the neighboring battery cells may lie between 50 μm and 200 μm (e.g. between 50 μm and 100 μm), for example. For example, the minimum lateral distance between the neighboring battery cells may be a smallest lateral distance between the neighboring battery cells measured in a direction along (or parallel to) a main surface of a substrate (e.g. an embedding structure) in which the battery cells 101 are located.

A lateral dimension of the embedding structure 103 may be chosen such that a minimum distance, L, between the encapsulation structures 102 of neighboring battery cells 101 may lie between 30 μm and 150 μm (or e.g. between 50 μm and 100 μm, or e.g. between 60 μm and 90 μm). Therefore, the lateral dimension of the embedding structure 103 between neighboring battery cells may lie between 30 μm and 150 μm (or e.g. between 50 μm and 100 μm, or e.g. between 60 μm and 90 μm). The lateral dimension may be a width of the embedding structure 103 measured in a direction along (or parallel to) a main surface of a substrate (e.g. the embedding structure 103) in which the battery cell 101 is located, or in a direction along (or parallel to) a main surface of the membrane structure, for example. A distance between the encapsulation structures 102 of neighboring battery cells 101 may be larger than or equal to the minimum distance, for example.

The embedding structure 103 (or the embedding material of the embedding structure) may be more brittle than the encapsulation structure 102 (e.g. more brittle than the encapsulation material of the encapsulation structure). Thus, in case of an external impact, breakage may occur in the embedding structure 103 instead of the encapsulation structure 102, for example.

The embedding material of the embedding structure 103 may have the first shear strength and the encapsulation material of the encapsulation structure 102 may have the second shear strength, for example. Shear strength may be the degree to which a material or bond is able to resist shear stress, for example. Shear stress may be a component of stress or a force vector component coplanar or parallel with a cross section of the material, for example. For example, shear strength may be the strength of the material against yield or structural failure where the material fails due to shear stress.

The (first) shear strength of the embedding material of the embedding structure 103 may be less than 30% (or e.g. less than 20% or e.g. less than 10%) of the (second) shear strength of the encapsulation material of the encapsulation structure 102, for example. For example, the embedding material of the embedding structure 103 may succumb, break or fracture more easily than the encapsulation material of the encapsulation structure 102 when a shear force is applied to the battery 100.

The embedding material of the embedding structure 103 may have a first tensile strength and the encapsulation material of the encapsulation structure 102 may have a second tensile strength, for example. Tensile strength (or ultimate tensile strength) (measured in force per unit area) may be a maximum stress that a material can withstand due to stretching or pulling before failure or breakage, for example.

The embedding material of the embedding structure 103 may have a first compressive strength and the encapsulation material of the encapsulation structure 102 may have a second compressive strength, for example. Compressive strength may be a value of uniaxial compressive stress (measured in force per unit area) that a material can withstand due to compression (e.g. uniaxial compression) before failure or breakage, for example.

Additionally, alternatively or optionally, the first shear strength of the embedding material of the embedding structure 103 may be smaller than (e.g. more than 10% smaller than or e.g. more than 30% smaller than) the first tensile strength of the embedding material of the embedding structure 103, for example. Additionally or optionally, the first shear strength of the embedding material of the embedding structure 103 may be less than a compressive strength value of the embedding material of the embedding structure 103. For example, the first shear strength value may be less than 90% (or e.g. less 70% or e.g. less than 50%) of the compressive strength value of the embedding material.

Additionally or optionally, the second shear strength of the encapsulation material of the encapsulation structure 102 may be smaller than the second tensile strength of the encapsulation material of the encapsulation structure 102, for example. For example, the second shear strength of the encapsulation material of the encapsulation structure 102 may be less than 95% (or e.g. less than 75% or e.g. less than 50%) of the second tensile strength of the encapsulation material of the encapsulation structure 102.

The encapsulation material of at least part of the encapsulation structure 102 may include a metal, for example. For example, the material of the first encapsulation element and the material of the second encapsulation element may include or may be metals. For example, the encapsulation material (of the encapsulation structure) may include a noble metal. For example, the encapsulation materials may include magnesium, manganese, molybdenum, nickel, niobium, osmium, palladium, platinum, and/or gold, or an alloy of two or more of these materials.

In the metal, the torsion (or shear) modulus may be slightly smaller than the Young's modulus (e.g. from Force=elongation×spring constant). In the strength of materials, Stress (Force/area)=elongation×Young's modulus (or torsions modulus), e.g. in torsion of a component, for example. If the torsion (or shear) modulus is substantially smaller, the material may be substantially more stretched to achieve the same resistance against the external force. ¼ of the torsion modulus compared to the Young's modulus may mean a four fold expansion, for example. The atoms are then, so far from each other, that the material cannot hold it self together, for example.

A torsions modulus of the encapsulation material of the encapsulation structure 102 may be less than 95% (or e.g. less than 75% or e.g. less than 50%) of a Young's modulus of the encapsulation material of the encapsulation structure 102. For example, palladium may have a torsion modulus of 50×10³ N/mm² and a Young's modulus of 117×10³ N/mm². For example, magnesium may have a torsion modulus of 19×10³ N/mm² and a Young's module of 46×10³ N/mm².

The embedding structure 103 may be more brittle than the encapsulation structure 102 and in case of an external impact, breakage may occur in the embedding structure 103 instead of the encapsulation structure 102, for example. For example, brittle materials are normally not loadable with torsion or shear stress. Glass, ceramics or semiconductors (e.g. single crystals or semiconductor wafers) may be brittle materials, for example. Additionally, the brittleness may be expressed (or partially estimated) as a difference between SIGMAX (for tensile and compressive strength) und TAUMAX (for shear strength).

The embedding material of the embedding structure 103 may include a semiconductor, a ceramic or glass. For example, the embedding structure 103 may comprise substantially a semiconductor, a ceramic or glass. For example, the embedding structure 103 may have a semiconductor, ceramic or glass content of more than 80% (or e.g. more than 90%). For example, the embedding material may include aluminum oxide, an epoxide, monocrystalline silicon, quartz, plexiglass, or borophosphosilicate glass.

For example, aluminum oxide may have a shear strength (TAUMAX) of 1×10⁶ N/m² and a compressive strength (SIGMAX) of 6×10⁷ N/m². For example, epoxide may have a shear strength (TAUMAX) of 2×10⁷ N/m² and a compressive strength (SIGMAX) of 3×10⁷ N/m². For example, monocrystalline silicon may have a shear strength (TAUMAX) of 1×10³ N/m² and a compressive strength (SIGMAX) of 5×10⁸ N/m². For example, quartz may have a shear strength (TAUMAX) of 1×10³ N/m² and a compressive strength (SIGMAX) of 3×10⁸ N/m². For example, borophosphosilicate glass may have a shear strength (TAUMAX) of 1×10³ N/m² and a compressive strength (SIGMAX) of 3×10 N/m². For example, plexiglass may have a shear strength (TAUMAX) of 2×10⁷ N/m² and a compressive strength (SIGMAX) of 6×10 N/m².

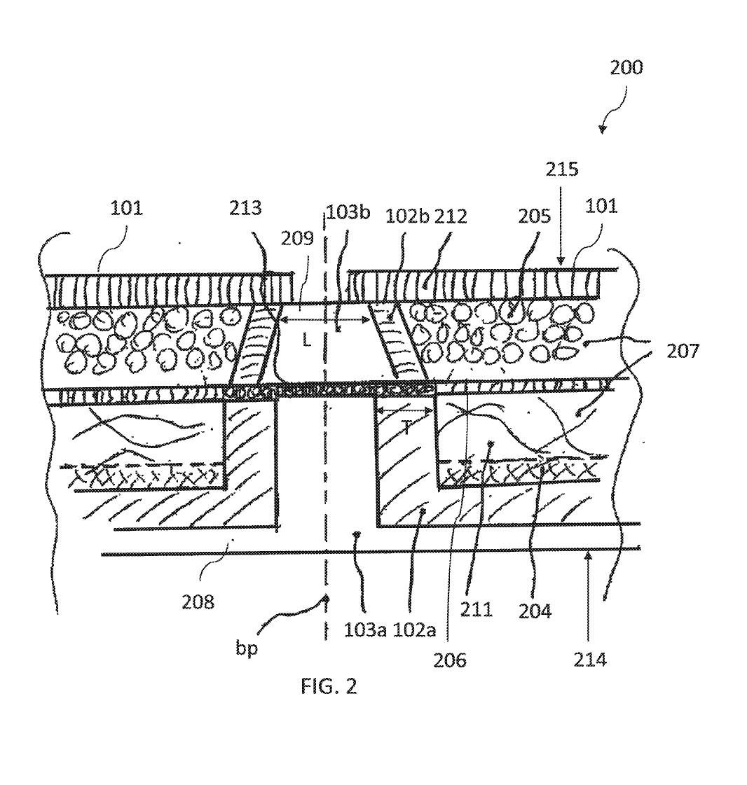

More details and aspects are mentioned in connection with the embodiments described above or below. The embodiment shown in FIG. 1B may comprise one or more optional additional features corresponding to one or more aspects mentioned in connection with the proposed concept or one or more embodiments described above (e.g. FIG. 1A) or below (FIGS. 2 to 6).

FIG. 2 shows a schematic illustration of a further battery 200 according to an embodiment.

The implementation of the battery 200 may be similar to the implementation of the battery shown and described in connection with FIGS. 1A and 1B.

A (or each) battery cell 101 of the plurality of battery cells may include an anode structure 204, a cathode structure 205 and a membrane structure 206 located between the anode structure 204 and the cathode structure 205. The electrolyte 207 may transport lithium ions between the anode structure 204 and the cathode structure 205 through the membrane structure 206, for example. The material of the membrane structure 206 may include aluminum oxide or glass fibers, for example. For example, the membrane structure 206 may be a porous aluminum oxide membrane layer or a glass fiber membrane layer. The battery cell 101 may optionally further include at least one glass fiber matrix 211 formed in the anode structure 204 and/or the cathode structure to absorb the liquid electrolyte, for example.

The first encapsulation element 102a of the encapsulation structure 102 may be located (or formed) in a (first) trench (or hole or recess) formed within a first supporting substrate 208. For example, the first encapsulation element 102a of the encapsulation structure 102 may be formed on (e.g. directly on) the sidewalls and bottom wall of the (first) trench of the first supporting substrate 208.

The anode structure 204 may be formed or located in the trench of the first supporting substrate 208, for example. The anode structure 204 may be or may comprise a metallic lithium layer, which may have a thickness which lies between 50 μm and 100 μm, for example. The anode structure 204 (or the metallic lithium layer) may be located on or formed on at least a portion of the first encapsulation element 102a covering the bottom wall of the trench, for example.

The first supporting substrate 208 may represent or may be a first portion 103a of the embedding structure 103. For example, at least part of the first supporting substrate 208 may form or may be part of the first portion 103a of the embedding structure 103. For example, the first supporting substrate 208 may be a silicon substrate, a glass substrate, a ceramic substrate, or a semiconductor wafer (e.g. a monocrystalline semiconductor wafer). Additionally or optionally, the first supporting substrate 208 may be a substrate comprising more than 50% (e.g. more than 80% or e.g. more than 90%) aluminum oxide, epoxide, monocrystalline silicon, quartz, plexiglass, or borophosphosilicate glass.

The first supporting substrate 208 may have a substrate thickness which lies between 200 μm and 500 μm (or e.g. between 100 μm and 400 μm or e.g. between 200 μm and 350 μm), for example. The substrate thickness may be an average thickness measured between a first main surface (e.g. a top surface) of the first supporting substrate 208 and a second opposite main surface (e.g. a bottom surface) of the first supporting substrate 208, for example.

The anode structure 204 may include an electrical contact structure configured to provide an electrical bias to the battery cell 101. For example, an electrical contact structure of the anode structure 204 may include a structured metal contact in electrical contact or connection with an anode material of the anode structure 204. The electrical contact structure (e.g. a structured metal contact) may be formed on a bottom (or back) side 214 (or surface) of the first supporting substrate 208, for example.

The second encapsulation element 102b of the encapsulation structure 102 of the battery cell 101 may be located (or formed) in a (second) trench (or hole or recess) formed within a second supporting substrate 209. For example, the second encapsulation element 102b of the encapsulation structure 102 may be formed on (e.g. directly on) the sidewalls of the (second) trench of the second supporting substrate 209.

The cathode structure 205 may be also formed or located in the trench. The cathode structure 205 may be formed from or may include Ni—Co—Al—Li-Oxide (nickel cobalt aluminum lithium oxide), which may be deposited in the trench of the second supporting substrate 209.

The cathode structure 205 may include an electrical contact structure configured to provide an electrical bias to the battery cell 101. For example, an electrical contact structure of the cathode structure 205 may include a structured metal contact 212 covering the cathode material of the cathode structure 205 of the battery cell 101, for example. The electrical contact structures (e.g. the structured metal contact 212) may be part of the encapsulation structure (e.g. encapsulation structure 102b) or may have the same or similar properties as the encapsulation structure 102b. For example, the embedding structure (e.g. the first portion of the embedding structure 103a and the second portion of the embedding structure 103b) may be more brittle than the structured metal contact 212. The electrical contact structure (e.g. the structured metal contact 212) may be formed on a front (or top) side 215 (or surface) of the second supporting substrate 209, for example.

The second supporting substrate 209 may represent a second portion 103b of the encapsulation structure 103. For example, at least part of the second supporting substrate 209 may form the second portion 103b of the embedding structure 103, for example. For example, the second supporting substrate 209 may be a silicon substrate, a glass substrate, a ceramic substrate, or a semiconductor wafer (e.g. a monocrystalline semiconductor wafer). Additionally or optionally, the second supporting substrate 209 may be a substrate comprising more than 50% (e.g. more than 80% or e.g. more than 90%) aluminum oxide, epoxide, monocrystalline silicon, quartz, plexiglass, or borophosphosilicate glass, for example.

The second supporting substrate 209 may have a substrate thickness which lies between 200 μm and 500 μm (or e.g. between 100 μm and 400 μm or e.g. between 200 μm and 350 μm), for example. The substrate thickness may be an average thickness measured between a first main surface (e.g. a top surface) of the second supporting substrate 209 and a second opposite main surface (e.g. a bottom surface) of the second supporting substrate 209, for example.

The first supporting substrate 208 and the second supporting substrate 209 may be formed from the same materials. Alternatively or optionally, the first supporting substrate 208 and the second supporting substrate 209 may be formed from different materials. For example, the first supporting substrate 208 may be a silicon wafer substrate and the second supporting substrate 209 may be a glass substrate.

The first supporting substrate 208 and the second supporting substrate 209 may be attached or joined by a joining material 213. The joining material may be a heat resistant material, or a heat resistant adhesive or glue, for example. The joining material 213 may be arranged between a main (top or front) surface of the first supporting substrate 208 and a main (bottom or back) surface of the second supporting substrate 209. The joining material 213 may join the main surface of the first supporting substrate 208 to the main surface of the second supporting substrate 209 directly or with a membrane layer (e.g. part of a membrane structure 206) in between, for example. The joining material 213 may join the main surface of the first supporting substrate 208 to the main surface of the second supporting substrate 209 such that the anode structure 204 (formed in the first supporting substrate 208), the membrane structure 206, and the cathode structure 205 (formed in the second supporting substrate 209) form a battery cell 101. Additionally or optionally, the joining material 213 may join a part of the first encapsulation element 102a of the encapsulation structure 102 and a part of the second encapsulation element 102b of the encapsulation structure 102 such that the encapsulation structure 102 is formed on at least one side of the battery cell 101.

The battery 200 may include additional metal layers formed respectively on the back side of the battery 200 and/or on the front side of the battery 200. For example, at least one first metal layer may be formed on the back (or bottom) side 214 of the first supporting substrate 208. For example, at least one second metal layer may be formed on the front side 215 (or surface) of the second supporting substrate 209. For battery cells 101 electrically connected in parallel, the at least one first metal layer may electrically connect the respective anode structures 204 of the respective battery cells 101 of the plurality of battery cells 101 to each other, for example. The at least one second metal layer may electrically connect the respective cathode structures 205 of the respective battery cells 101 of the plurality of battery cells 101 to each other, for example.

Parallel connected metallic encapsulated (battery) cells may be embedded in a fragile body, so that in case of an external impact and a battery cell 101 is unavoidably broken, the breakage occurs along the connecting points, which consist of a brittle, easily breakable body, for example. As the individual battery cells 101 remain intact, the lithium may be prevented from contacting the surrounding humidity or water, for example. This may improve safety as a reaction of metallic lithium with water or humidity may form lithium hydroxide and hydrogen, which may be flammable, for example.

The battery 200 may reduce or prevent the release of lithium in case of mechanical destruction of the battery. The battery 200 may further allow larger battery cells 101 with higher energy density and lower internal resistance using metallic lithium as an anode (negative polarity) to be formed, without compromising safety levels.

For example, the battery 200 may include a silicon wafer (as the first supporting substrate 208), a metallic Li anode (as the anode structure 204), a glass wafer (as the second supporting substrate 209), a Ni—Co—Al—Li-Oxide cathode (as the cathode structure 205), a metal (as a cathode cover 212), and a glass fiber mat or matrix 211 to absorb a liquid electrolyte 207, for example. The silicon wafer and glass wafer may be joined together by a temperature resistant material 213. The inner wall of the battery cells regions may be lined with a strong metal 102a. 102b so that in case of external impact, the parallel connected battery cells may preferably break up along the line (bp) which runs through the brittle connecting body 103a, 103b, for example.

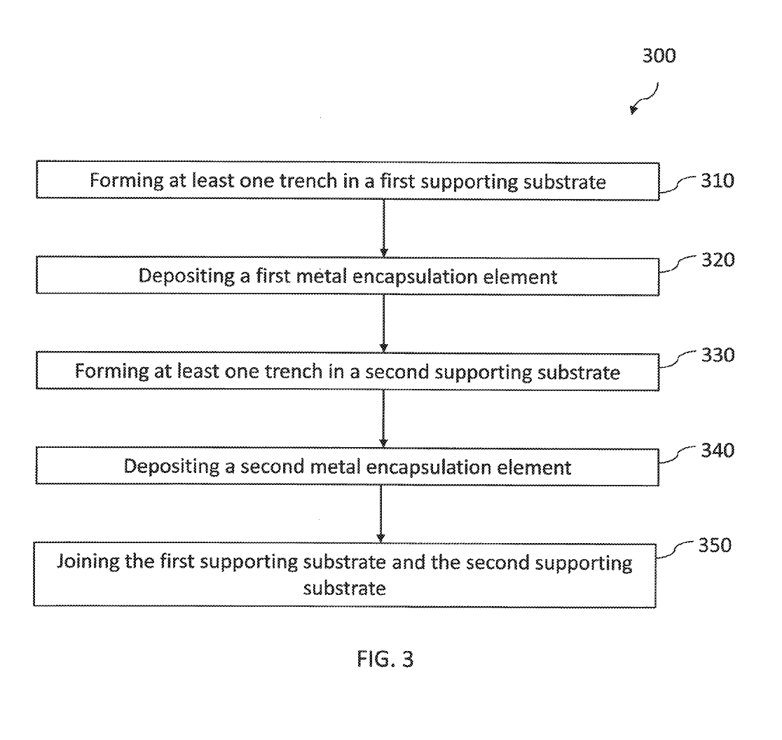

More details and aspects are mentioned in connection with the embodiments described above or below. The embodiments shown in FIG. 2 may comprise one or more optional additional features corresponding to one or more aspects mentioned in connection with the proposed concept or one or more embodiments described above (e.g. FIGS. 1A to 1B) or below (FIGS. 3 to 6).

FIG. 3 shows a flow chart of a method 300 for forming a battery cell arrangement according to an embodiment.

The method 300 includes forming 310 at least one trench in a first supporting substrate and depositing 320 a first metal encapsulation element of an encapsulation structure in the at least one trench of the first supporting substrate.

The method 300 further includes forming 330 at least one trench in a second supporting substrate and depositing 340 a second metal encapsulation element of the encapsulation structure in the at least one trench of the second supporting substrate.

The method 300 further includes joining 350 the first supporting substrate and the second supporting substrate so that the encapsulation structure is formed around a battery cell.

Due to the formation of the encapsulation structure around the battery cell, safer battery cells may be produced. Due to the encapsulation structure formed around the battery cell, in case of an external impact, the encapsulation structure may be unbroken, leaving the battery cell intact, for example.

The (first) trench formed in the first supporting substrate may have a lateral dimension of between 5 mm and 20 mm (e.g. between 5 mm and 10 mm). The lateral dimension may be a distance between a first sidewall of the trench and a second opposite sidewall of the trench measured along (or parallel to) a main surface (e.g. a top surface or bottom surface) of the first supporting substrate, for example. Optionally, the lateral dimension may be a length of a diagonal or a diameter of the trench measured along (or parallel to) a main surface (e.g. a top surface or bottom surface) of the first supporting substrate, for example.

The (first) trench may have a trench depth equal to less than 50% (or e.g. less than 706 or e.g. less than 80%) of the thickness of the first supporting substrate, for example. The trench depth may be a length measured from an opening of the trench at a main surface (e.g. a top surface) of the first supporting substrate to a bottom wall of the trench. The trench depth may be measured in direction substantially orthogonal (or perpendicular) to the main surface of the first supporting substrate, for example.

The (second) trench formed in the second supporting substrate may have a lateral dimension of between 5 mm and 20 mm (e.g. between 5 mm and 10 mm). The lateral dimension may be a distance between a first sidewall of the trench and a second opposite sidewall of the trench measured along (or parallel to) a main surface (e.g. a top surface or bottom surface) of the second supporting substrate, for example. Optionally, the lateral dimension may be a length of a diagonal or a diameter of the trench measured along (or parallel to) a main surface (e.g. a top surface or bottom surface) of the second supporting substrate, for example.

The (second) trench may have a trench depth equal to a thickness of the second supporting substrate, for example. The trench depth may be measured in direction substantially orthogonal (or perpendicular) to the main surface of the first supporting substrate, for example. The (second) trench may be a hole or recess etched through the entire thickness of the second supporting substrate.

The first metal encapsulation element and the second metal encapsulation element may be formed by depositing the at least one metallic layer in the trench structures. For example, the first metal encapsulation element of an encapsulation structure (e.g. at least one metallic layer) may be formed on (e.g. directly on) the sidewalls and optionally on a bottom wall of the trench formed in the first supporting substrate, for example. The second metal encapsulation element of an encapsulation structure (e.g. at least one metallic layer) may be formed on (e.g. directly on) the sidewalls and optionally on the bottom wall of the trench formed in the second supporting substrate, for example.

The first supporting substrate and the second supporting substrate may be joined before forming the at least one trench in the second supporting substrate and before depositing the second metal encapsulation element in the trench of the second supporting substrate. The first supporting substrate and the second supporting substrate may be joined after forming the membrane structure over the opening of the trench in the first supporting substrate or after forming the membrane structure on the second supporting substrate, for example.

The method 300 may further include forming an anode structure (comprising metallic lithium) in the (first) trench of the first supporting substrate (before joining the first supporting substrate and the second supporting substrate).

For example, after joining the first supporting substrate and the second supporting substrate, the (second) trench may be formed in the second supporting substrate and subsequently the second metal encapsulation element may be formed in the trench of the second supporting substrate.

The method 300 may further include depositing a cathode material of the cathode structure in the trench of the second supporting substrate after forming the trench in the second supporting substrate, for example.

The method 300 may further include forming at least one glass fiber matrix in the trench of the first supporting substrate and/or the trench of the second supporting substrate before joining the first supporting substrate and the second supporting substrate, for example. Additionally, the method 300 may further include incorporating an electrolyte into the trench of the first supporting substrate and/or the trench of the second supporting substrate before joining the first supporting substrate and the second supporting substrate, for example.

The method 300 may further include forming a membrane structure before joining the first supporting substrate and the second supporting substrate. For example, the membrane structure may be formed over an opening of the (first) trench in the first supporting substrate after forming the anode structure. Subsequently, the first supporting substrate (carrying or supporting the membrane structure) and the second supporting substrate may be joined by the joining material. Alternatively or optionally, the membrane structure may be formed on a back (or bottom) side of the second supporting substrate before or after forming the (second) trench in the second supporting substrate, or before or after forming the cathode structure in the (second trench). Subsequently, the first supporting substrate and the second supporting substrate (carrying or supporting the membrane structure) may be joined by the joining material.

The method 300 may further include forming an electrical contact structure of the cathode structure after depositing the cathode material at least partially in the (second) trench in the second supporting substrate. For example, the method 300 may further include forming the electrical contact structure (e.g. a structured metal contact) on the cathode material of the cathode structure, for example. The method 300 may further include forming the electrical contact structure (e.g. the structured metal contact) after forming the at least one glass fiber matrix in the trench of the first supporting substrate and/or the trench of the second supporting substrate and/or after incorporating the electrolyte into the trench of the first supporting substrate and/or the trench of the second supporting substrate, for example.

To electrically connect the battery cells in parallel, the method 300 may further include forming at least one first metal layer on a back side or surface of the first supporting substrate and forming at least one second metal layer on a front side or surface of the second supporting substrate. The at least one first metal layer may electrically connect respective anode structures of respective battery cells of the plurality of battery cells to each other, for example. The at least one second metal layer may electrically connect respective cathode structures of respective battery cells of the plurality of battery cells to each other, for example.

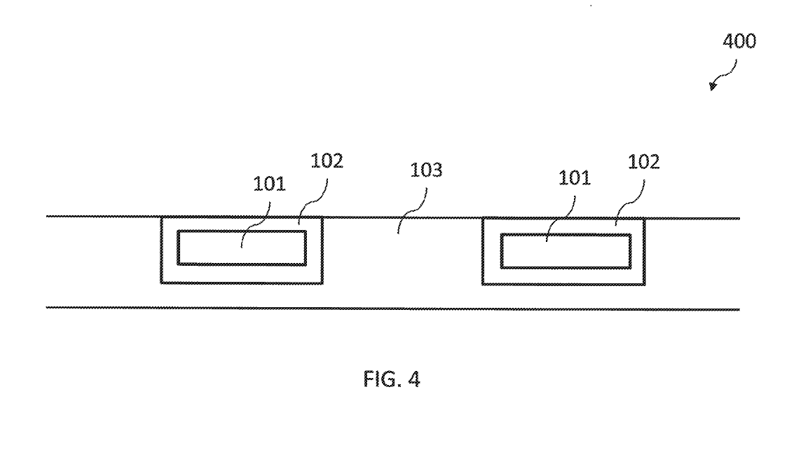

More details and aspects are mentioned in connection with the embodiments described above or below. The embodiments shown in FIG. 3 may comprise one or more optional additional features corresponding to one or more aspects mentioned in connection with the proposed concept or one or more embodiments described above (e.g. FIGS. 1A to 2) or below (FIGS. 4 to 6).

FIG. 4 shows a schematic illustration of a battery 400 according to an embodiment.

The battery 400 comprises a plurality of battery cells 101, wherein the battery cells of the plurality of battery cells are respectively encapsulated by an encapsulation structure 102.

The battery 400 comprises an embedding structure 103 separating neighboring battery cells 101 of the plurality of battery cells 101. An embedding material of at least a part of the embedding structure 103 is arranged between the neighboring battery cells 101. A shear strength of an encapsulation material of at least a part of the encapsulation structure (102) is larger than a tensile strength of the embedding material of at least a part of the embedding structure (103).

Due to the (second) shear strength of the encapsulation material of at least a part of the encapsulation structure 102 being larger than the (first) tensile strength of the embedding material of at least a part of the embedding structure 103, safety of batteries (e.g. lithium ion batteries) may be improved, and potential hazards may be reduced, for example. For example, in case of an external impact, breakage may occur along breakage points of the embedding structure 103, while the encapsulation structure 102 may be unbroken, thus leaving the individual battery cells 101 intact, for example.

The implementation of the battery 400 may be similar to the implementation of the batteries shown and described in connection with FIGS. 1A, 1B, 2 and 3.

The (second) shear strength of the encapsulation material of the encapsulation structure 102 may be more than 30% larger than (e.g. more than 50% larger than or e.g. more than 70% larger than) the first tensile strength of the embedding material of the embedding structure 103, for example. Additionally or optionally, the first shear strength of the embedding material of the embedding structure 103 may be less than a compressive strength value of the embedding material of the embedding structure 103. For example, the first shear strength value may be less than 90% (or e.g. less 70% or e.g. less than 50%) of the first compressive strength value of the embedding material.

Additionally or optionally, the first shear strength of the embedding material of the embedding structure 103 may be less than 30% (or e.g. less than 20% or e.g. less than 10%) of the second shear strength of the encapsulation material of the encapsulation structure 102, for example. For example, the embedding material of the embedding structure 103 may succumb, break or fracture more easily than the encapsulation material of the encapsulation structure 102 when a shear force is applied to the battery 400.

For example, the first shear strength of the embedding material of the embedding structure 103 may be much smaller than the second tensile strength of the encapsulation material of the encapsulation structure 102. For example, the second shear strength of the encapsulation material of the encapsulation structure 102 may be much larger than the first tensile strength of the embedding material of the embedding structure 103.

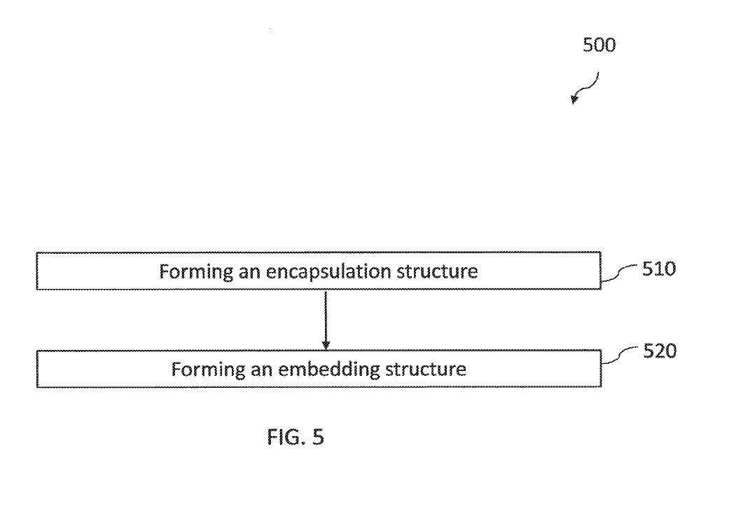

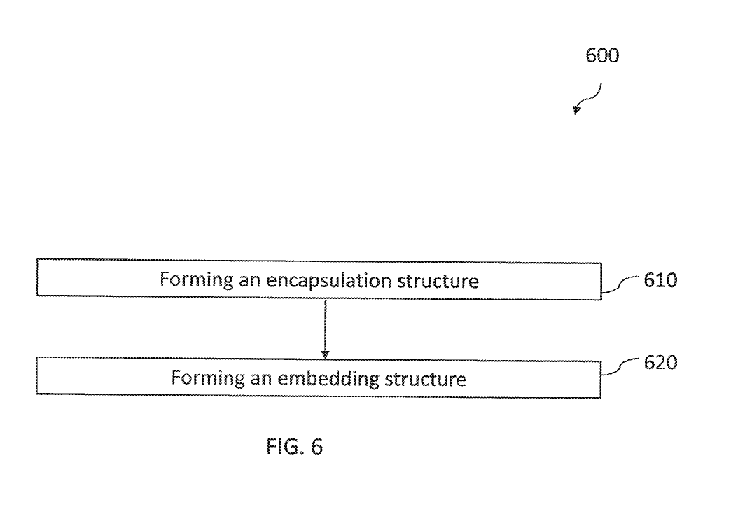

More details and aspects are mentioned in connection with the embodiments described above or below. The embodiments shown in FIG. 4 may comprise one or more optional additional features corresponding to one or more aspects mentioned in connection with the proposed concept or one or more embodiments described above (e.g. FIGS. 1A to 3) or below (FIGS. 5 to 6).

FIG. 5 shows a flow chart of a method 500 for forming a battery according to an embodiment.

The method 500 includes forming 510 an encapsulation structure to encapsulate respective battery cells of a plurality of battery.

The method 500 further includes forming 520 an embedding structure separating neighboring battery cells of the plurality of battery cells. An embedding material of at least a part of the embedding structure is arranged between the neighboring battery cells has a first shear strength. A shear strength of the embedding material of at least a part of the embedding structure is less than 30% of a shear strength of an encapsulation material of at least a part of the encapsulation structure.

Due to the formation of an embedding structure, and a shear strength of the embedding material of at least a part of the embedding structure being less than 30% of a shear strength of an encapsulation material of at least a part of the encapsulation structure, the safety of the batteries (e.g. lithium ion batteries) may be improved, and potential hazards may be reduced, for example. For example, in case of an external impact, breakage may occur along breakage points of the embedding structure, while the encapsulation structure may be unbroken, thus leaving the individual battery cells intact, for example.

More details and aspects are mentioned in connection with the embodiments described above or below. The embodiments shown in FIG. 5 may comprise one or more optional additional features corresponding to one or more aspects mentioned in connection with the proposed concept or one or more embodiments described above (e.g. FIGS. 1A to 4) or below (FIG. 6).

FIG. 6 shows a flow chart of a method 600 for forming a battery according to an embodiment.

The method 600 includes forming 610 an encapsulation structure to encapsulate respective battery cells of a plurality of battery.

The method 600 further includes forming 620 an embedding structure separating neighboring battery cells of the plurality of battery cells. An embedding material of at least a part of the embedding structure is arranged between the neighboring battery cells. A shear strength of an encapsulation material of at least a part of the encapsulation structure is larger than a tensile strength of the embedding material of at least a part of the embedding structure.

Due to the formation of an embedding structure, and a shear strength of the encapsulation material of at least a part of the encapsulation structure being larger than a tensile strength of the embedding material of at least a part of the embedding structure, safety of batteries (e.g. lithium ion batteries) may be improved, and potential hazards may be reduced, for example. For example, in case of an external impact, breakage may occur along breakage points of the embedding structure, while the encapsulation structure may be unbroken, thus leaving the individual battery cells intact, for example.

More details and aspects are mentioned in connection with the embodiments described above or below. The embodiments shown in FIG. 6 may comprise one or more optional additional features corresponding to one or more aspects mentioned in connection with the proposed concept or one or more embodiments described above (e.g. FIGS. 1A to 5) or below.

Various embodiments relate to (battery) cell structures with shatter resistance encapsulation for lithium ion batteries.

Various embodiments relate to a secondary lithium ion battery (rechargeable lithium ion battery) with metallic lithium as an anode.

Aspects and features (e.g. the battery, the battery cell, the shear strength value of the embedding material, the shear strength value of the encapsulation material, the encapsulation structure, the encapsulation material of the first encapsulation element, the encapsulation material of the second encapsulation element, the first encapsulation element, the second encapsulation element, the embedding structure, the embedding material of the embedding structure, the first portion of the embedding structure, the second portion of the embedding structure, the first supporting substrate, the second supporting substrate, the tensile strength value of the embedding material, the tensile strength value of the encapsulation material, the compressive strength value of the embedding material, the compressive strength value of the encapsulation material, the anode structure, the cathode structure, the membrane structure, the glass fiber mat or matrix, and the electrolyte) mentioned in connection with one or more specific examples may be combined with one or more of the other examples.

Example embodiments may further provide a computer program having a program code for performing one of the above methods, when the computer program is executed on a computer or processor. A person of skill in the art would readily recognize that acts of various above-described methods may be performed by programmed computers. Herein, some example embodiments are also intended to cover program storage devices, e.g., digital data storage media, which are machine or computer readable and encode machine-executable or computer-executable programs of instructions, wherein the instructions perform some or all of the acts of the above-described methods. The program storage devices may be, e.g., digital memories, magnetic storage media such as magnetic disks and magnetic tapes, hard drives, or optically readable digital data storage media. Further example embodiments are also intended to cover computers programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. It will thus be appreciated that those skilled in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

Functional blocks denoted as “means for . . . ” (performing a certain function) shall be understood as functional blocks comprising circuitry that is configured to perform a certain function, respectively. Hence, a “means for s.th.” may as well be understood as a “means configured to or suited for s.th.” A means configured to perform a certain function does, hence, not imply that such means necessarily is performing the function (at a given time instant).

Functions of various elements shown in the figures, including any functional blocks labeled as “means”, “means for providing a sensor signal”, “means for generating a transmit signal.”, etc., may be provided through the use of dedicated hardware, such as “a signal provider”, “a signal processing unit”, “a processor”, “a controller”, etc. as well as hardware capable of executing software in association with appropriate software. Moreover, any entity described herein as “means”, may correspond to or be implemented as “one or more modules”, “one or more devices”, “one or more units”, etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the Detailed Description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective acts of these methods.

Further, it is to be understood that the disclosure of multiple acts or functions disclosed in the specification or claims may not be construed as to be within the specific order. Therefore, the disclosure of multiple acts or functions will not limit these to a particular order unless such acts or functions are not interchangeable for technical reasons. Furthermore, in some embodiments a single act may include or may be broken into multiple sub acts. Such sub acts may be included and part of the disclosure of this single act unless explicitly excluded.

What is claimed is:

1. A battery, comprising:
a plurality of battery cells encapsulated by an encapsulation structure; and
an embedding structure separating neighboring ones of the battery cells,
wherein an embedding material of at least a part of the embedding structure is arranged between the neighboring battery cells,
wherein a shear strength of the embedding material is less than 30% of a shear strength of an encapsulation material of at least a part of the encapsulation structure.

2. The battery of claim 1, wherein the shear strength of the embedding material is less than 10% of the shear strength of the encapsulation material.

3. The battery of claim 1, wherein the encapsulation material comprises a metal.

4. The battery of claim 1, wherein the embedding material comprises a ceramic, glass, a monocrystalline semiconductor, aluminum oxide, an epoxide, monocrystalline silicon, quartz, plexiglass, or borophosphosilicate glass.

5. The battery of claim 1, wherein the battery cells are lithium ion battery cells.

6. The battery of claim 1, wherein a battery cell of the plurality of battery cells comprises:
an anode structure comprising a metallic lithium layer;
a cathode structure; and
an electrolyte for transporting lithium ions between the anode structure and the cathode structure.

7. The battery of claim 6, wherein the metallic lithium layer has a thickness in a range between 50 μm and 100 μm.

8. The battery of claim 6, wherein the encapsulation structure comprises an encapsulation element adjacent to at least part of the anode structure, and wherein the anode structure and the encapsulation element are disposed in a trench formed within a first supporting substrate which forms a first portion of the embedding structure.

9. The battery of claim 6, wherein the encapsulation structure comprises an encapsulation element adjacent to at least part of the cathode structure, and wherein the cathode structure and the encapsulation element are disposed in a trench formed within a supporting substrate which forms a portion of the embedding structure.

10. The battery of claim 6, further comprising a membrane structure between the anode structure and the cathode structure.

11. The battery of claim 1, wherein the embedding structure comprises a first supporting substrate and a second supporting substrate, and wherein the first supporting substrate and the second supporting substrate are joined by a heat resistant material.

12. The battery of claim 1, wherein a battery cell of the plurality of battery cells has a maximum lateral dimension in a range between 5 mm and 20 mm.

13. The battery of claim 1, wherein the encapsulation structure has a minimum thickness in a range between 20 μm and 30 μm.

14. The battery of claim 1, wherein a minimal distance between encapsulation structures of neighboring battery cells is in a range between 50 μm and 100 μm.

15. The battery of claim 1, wherein the shear strength of the encapsulation material is larger than a tensile strength of the embedding material.

16. A battery, comprising:
a plurality of battery cells encapsulated by an encapsulation structure; and
an embedding structure separating neighboring ones of the battery cells,
wherein an embedding material of at least a part of the embedding structure is arranged between the neighboring battery cells,
wherein a shear strength of an encapsulation material of at least a part of the encapsulation structure is larger than a tensile strength of the embedding material.

17. The battery of claim 16, wherein the shear strength of the encapsulation material is more than 30% larger than the tensile strength of the embedding material.

18. The battery of claim 16, wherein a shear strength of the embedding material is less than a compressive strength of the embedding material.

19. The battery of claim 18, wherein a shear strength of the embedding material is less than 70% of a compressive strength of the embedding material.

20. A method for forming a battery cell arrangement, the method comprising:
forming at least one trench in a first supporting substrate and depositing a first metal encapsulation element of an encapsulation structure in the at least one trench of the first supporting substrate;
forming at least one trench in a second supporting substrate and depositing a second metal encapsulation element of the encapsulation structure in the at least one trench of the second supporting substrate; and
joining the first supporting substrate and the second supporting substrate so that the encapsulation structure is formed around a battery cell.
